(19) United States
(12) Patent Application Publication
(10) Pub. No.: US 2024/0060930 A1
(43) Pub. Date: Feb. 22, 2024

(54) ION SENSOR AND ION SENSOR MANUFACTURING METHOD

(71) Applicant: HAMAMATSU PHOTONICS K.K., Hamamatsu-shi, Shizuoka (JP)

(72) Inventors: Toshiki WAKAMORI, Hamamatsu-shi, Shizuoka (JP); Shinichi NAKAHIGASHI, Hamamatsu-shi, Shizuoka (JP)

(73) Assignee: HAMAMATSU PHOTONICS K.K., Hamamatsu-shi, Shizuoka (JP)

(21) Appl. No.: 18/267,940

(22) PCT Filed: Sep. 22, 2021
(86) PCT No.: PCT/JP2021/034821

§ 371 Date: Jun. 16, 2023

(30) Foreign Application Priority Data
Dec. 25, 2020 (JP) 2020-216416

(51) Int. Cl. G01N 27/414

(52) U.S. Cl. CPC G01N 27/414

(57) ABSTRACT

The ion sensor includes a substrate and a plurality of detection units. Each detection unit includes an ID portion, an ICG electrode, a TG electrode, an SG electrode, an electrode pad, and an ion sensitive film. The SG electrode is disposed between the ICG electrode and the TG electrode on the main surface of the substrate. The electrode pad is electrically connected to the SG electrode and disposed on the opposite side of the SG electrode from the substrate. The ion sensitive film is provided on the surface of the electrode pad, and changes a potential according to change in ion concentration of the aqueous solution in contact with the ion sensitive film. A width of the ion sensitive film in a facing direction in which the ICG electrode and the TG electrode face each other is greater than a separation width between the ICG electrode and the TG electrode.

### TECHNICAL FIELD

The present disclosure relates to an ion sensor and a method of manufacturing the ion sensor.

### BACKGROUND ART

Non-Patent Document 1 discloses an ion sensor having sensitivity to a smell. The ion sensor has an aperture type pixel structure (hereinafter referred to as “aperture type structure”). More specifically, in each pixel, an opening is provided between a first electrode (ICG electrode) and a second electrode (TG electrode) on a semiconductor substrate, and an ion sensitive film (Si₃N₄) is disposed at the bottom of the opening. On the ion sensitive film, a polyaniline sensitive film as a medium containing a substance to be detected (for example, a smell substance) is formed.

### CITATION LIST

### Non-Patent Document

[Non-Patent Document 1] Naoya Shinmyo, Tatsuya Iwata, Kenichi Hashizume, Shunichiro Kuroki, Kazuaki Sawada (2017), Gas distribution imaging by charge transfer type sensor arrays using polyaniline sensitive film, 64th JSAP Spring Meeting, 16p-416-6.

### SUMMARY OF INVENTION

### Technical Problem

In the above-described ion sensor, in order to obtain sufficient sensitivity, it is necessary to sufficiently secure a contact area between the ion sensitive film and the medium. On the other hand, in the opening type structure as described in Non-Patent Document 1, since a part of the medium enters the opening, the contact area between the medium and the ion sensitive film depends on a size of the opening. In addition, there is a limit to increasing the size of the opening due to requirements such as the pixel size and the pixel pitch. For this reason, in the above-described opening type structure, it is sometimes difficult to secure a sufficient contact area.

Therefore, an object of an aspect of the present disclosure is to provide an ion sensor capable of effectively improving sensitivity and a method of manufacturing the ion sensor.

### Solution to Problem

An ion sensor according to one aspect of the present disclosure includes a substrate; and a plurality of pixels provided on a first surface of the substrate. Each pixel of the plurality of pixels includes a charge storage portion, a first electrode, a second electrode, a third electrode, a fourth electrode, and an ion sensitive film. The charge storage portion is formed in a region of the substrate along the first surface, and configured to accumulate charges to be injected into a potential well formed in a portion of the substrate overlapping with the third electrode when viewed in a thickness direction of the substrate. The first electrode is disposed on the first surface, and configured to control an amount of charge injection from the charge storage portion to the potential well. The second electrode is disposed on the first surface, and is configured to perform control for transferring charges from the potential well to the outside. The third electrode is disposed between the first electrode and the second electrode on the first surface. The fourth electrode is electrically connected to the third electrode and is disposed on an opposite side of the third electrode from the substrate. The ion sensitive film is provided on a surface of the fourth electrode on a side opposite to the substrate side, and configured to change a potential in accordance with a change in ion concentration of a medium in contact with the ion sensitive film. A width of the ion sensitive film in a facing direction in which the first electrode and the second electrode face each other is greater than a separation width between the first electrode and the second electrode.

In the ion sensor, the third electrode is disposed between the first electrode and the second electrode on the first surface of the substrate. The third electrode is electrically connected to the fourth electrode provided with the ion sensitive film. Thus, the function as an ion sensor is realized. More specifically, a change in the potential of the ion sensitive film can be transmitted to the substrate via the fourth electrode and the third electrode. This makes it possible to change the depth of the potential well in accordance with a change in the potential of the ion sensitive film. As a result, it is possible to detect the ion concentration of the test object brought into contact with the medium in contact with the ion sensitive film based on the amount of charges (that is, the amount corresponding to the depth of the potential well) taken out to the outside by controlling the first electrode and the second electrode.

Here, if a configuration (so-called opening type structure) in which an opening is provided between a first electrode and a second electrode and an ion sensitive film is provided at the bottom of the opening is adopted, the width of the ion sensitive film is limited by the size of the opening, and the width of the ion sensitive film cannot be made larger than the separation width between the first electrode and the second electrode. On the other hand, the above-described ion sensor adopts a configuration in which the potential change of the ion sensitive film is transmitted to the substrate through the third electrode and the fourth electrode, thereby realizing a configuration in which the ion sensitive film is wider than the separation width between the first electrode and the second electrode. Accordingly, the contact area between the ion sensitive film and the medium may be sufficiently secured, and the sensitivity of the ion sensor may be effectively improved.

A surface of the fourth electrode opposite to the substrate side may be a flat surface, and the ion sensitive film may be formed in a flat shape along the surface of the fourth electrode. According to the above-described configuration, the medium disposed on the ion sensitive film and the ion sensitive film can be sufficiently brought into close contact with each other compared to a case where the above-described opening type structure is adopted. Accordingly, the sensitivity of the ion sensor can be more effectively improved.

The first electrode and the third electrode may be spaced apart from each other, and a first separation width between the first electrode and the third electrode may be set in a range in which a potential barrier that inhibits injection of charges from the charge storage portion to the potential well does not occur. According to the above configuration, sufficient charge transfer efficiency from the charge storage portion to the potential well is secured.

The second electrode and the third electrode may be spaced apart from each other, and a second separation width between the second electrode and the third electrode may be set in a range in which a potential barrier that inhibits transfer of charges from the potential well to the outside does not occur. According to the above configuration, sufficient charge transfer efficiency from the potential well to the outside is secured.

A width of the third electrode in the facing direction is greater than or equal to 80% of the separation width between the first electrode and the second electrode. According to the above configuration, it is possible to suitably suppress the occurrence of the potential barrier described above.

A portion of the first electrode may overlap with the third electrode when viewed in the thickness direction. According to the above configuration, it is possible to reduce variations in the amount of charges accumulated in the potential well.

The portion of the first electrode may be disposed on an opposite side of the third electrode from the substrate. According to the above configuration, it is possible to lower a voltage value necessary for forming a potential well in a region overlapping with the third electrode in the substrate, compared to a case where a portion of the first electrode is disposed between the substrate and the third electrode.

A width in the facing direction of a first portion of the first electrode that overlaps with the third electrode may be smaller than a width in the facing direction of a second portion of the first electrode that does not overlap with the third electrode. According to the above configuration, it is possible to suppress unintended leakage of charges from the potential well to the charge storage portion.

The width of the first portion may be smaller than or equal to 25% of the width of the second portion. According to the above configuration, it is possible to suitably suppress unintended leakage of charges from the potential well to the charge storage portion.

A portion of the second electrode may overlap with the third electrode when viewed in the thickness direction. According to the above configuration, it is possible to improve the efficiency of charge transfer from the potential well to the outside.

The portion of the second electrode may be disposed on an opposite side of the third electrode from the substrate. According to the above configuration, it is possible to lower a voltage value necessary for forming a potential well in a region overlapping with the third electrode in the substrate, compared to a case where a portion of the second electrode is disposed between the substrate and the third electrode.

A width in the facing direction of a third portion of the second electrode that overlaps with the third electrode may be smaller than a width in the facing direction of a fourth portion of the second electrode that does not overlap with the third electrode. According to the above configuration, it is possible to suppress unintended leakage of charges from the potential well to the outside.

The width of the third portion may be smaller than or equal to 25% of the width of the fourth portion. According to the above configuration, it is possible to suitably suppress unintended leakage of charges from the potential well to the outside.

One pixel of the plurality of pixels may include a plurality of the ion sensitive films that react to ions different from each other. A plurality of the fourth electrodes may be provided corresponding to each of the plurality of the ion sensitive films. A plurality of the third electrodes may be provided corresponding to each of the plurality of the fourth electrodes. According to the above configuration, the amount of information obtained from one pixel can be increased. That is, it is possible to detect the concentrations of a plurality of types of ions by one pixel.

A method of manufacturing an ion sensor having: a substrate; and a first electrode, a second electrode, and a third electrode formed on the substrate according to another aspect of the present disclosure includes: forming a first insulating film on the substrate; forming the first electrode, the second electrode spaced apart from the first electrode, and the third electrode spaced apart from both the first electrode and the second electrode between the first electrode and the second electrode on the first insulating film; forming a second insulating film covering the first electrode, the second electrode, and the third electrode on the substrate; forming an opening in the second insulating film such that a portion of the third electrode is exposed, and forming a metal wiring in the opening, the metal wiring being electrically connected to the third electrode; forming a fourth electrode electrically connected to the metal wiring along a surface of the second insulating film opposite to the substrate side; and forming an ion sensitive film on a surface of the fourth electrode opposite to the substrate side, the ion sensitive film changing a potential in accordance with a change in ion concentration of a medium in contact with the ion sensitive film. In the forming the ion sensitive film, the ion sensitive film is formed such that a width of the ion sensitive film in a facing direction in which the first electrode and the second electrode face each other is greater than a separation width between the first electrode and the second electrode. According to the method of manufacturing an ion sensor, it is possible to obtain an ion sensor having the above-described effects.

A method of manufacturing an ion sensor having: a substrate; and a first electrode, a second electrode, and a third electrode formed on the substrate according to further another aspect of the present disclosure includes: forming a first insulating film on the substrate; forming the third electrode on the first insulating film; forming a second insulating film covering a surface of the third electrode; forming the first electrode such that a portion of the first electrode overlaps with the third electrode via the second insulating film when viewed in a thickness direction of the substrate, and forming the second electrode such that a portion of the second electrode overlaps with the third electrode via the second insulating film when viewed in the thickness direction of the substrate; forming a third insulating film covering the first electrode, the second electrode, and the third electrode on the substrate; forming an opening in the third insulating film such that a portion of the third electrode is exposed, and forming a metal wiring in the opening, the metal wiring being electrically connected to the third electrode; forming a fourth electrode electrically connected to the metal wiring along a surface of the third insulating film opposite to the substrate side; and forming an ion sensitive film on a surface of the fourth electrode opposite to the substrate side, the ion sensitive film changing a potential in accordance with a change in ion concentration of a medium in contact with the ion sensitive film. In the forming the ion sensitive film, the ion sensitive film is formed such that a width of the ion sensitive film in a facing direction in which the first electrode and the second electrode face each other is greater than a separation width between the first electrode and the second electrode.

According to the method of manufacturing an ion sensor, it is possible to obtain an ion sensor having the above-described effects.

### Advantageous Effects of Invention

According to an aspect of the present disclosure, it is possible to provide an ion sensor capable of effectively improving sensitivity and a method of manufacturing the ion sensor.

### BRIEF DESCRIPTION OF DRAWINGS

FIG. 1 is a schematic plan view of an ion sensor of a first embodiment.

FIG. 2 is a diagram schematically illustrating a cross-sectional configuration of a detection unit (pixel).

FIG. 3 is a diagram illustrating an operation example of the detection unit using the ID driving method.

FIG. 4 is a diagram illustrating an operation example of the detection unit using the ICG driving method.

FIG. 5 is a diagram illustrating an example of a potential barrier between the ICG electrode and the SG electrode and an example of a potential barrier between the TG electrode and the SG electrode.

FIG. 6 is a diagram illustrating arrangement dimensions of the ICG electrode, the TG electrode, and the SG electrode.

FIG. 7 is a diagram showing a manufacturing process of the ion sensor of the first embodiment.

FIG. 8 is a diagram schematically illustrating a cross-sectional configuration of a detection unit of an ion sensor of the second embodiment.

FIG. 9 is a diagram illustrating an operation example of the detection unit of the ion sensor of the second embodiment.

FIG. 10 is a diagram showing a manufacturing process of the ion sensor of the second embodiment.

FIG. 11 is a diagram schematically illustrating a cross-sectional configuration of a detection unit of an ion sensor of the third embodiment.

FIG. 12 is a diagram illustrating a first modification example of an ion sensor.

FIG. 13 is a diagram illustrating a second modification example of an ion sensor.

### DESCRIPTION OF EMBODIMENTS

Hereinafter, embodiments of the present invention will be described in detail with reference to the drawings. In the drawings, the same or corresponding portions are denoted by the same reference numerals, and redundant description is omitted.

### First Embodiment

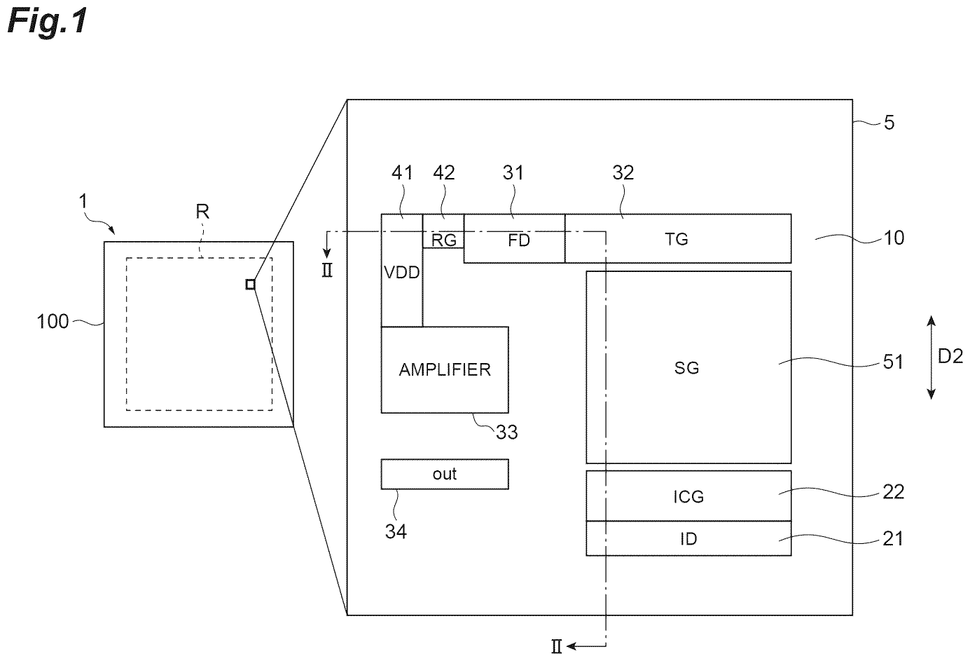

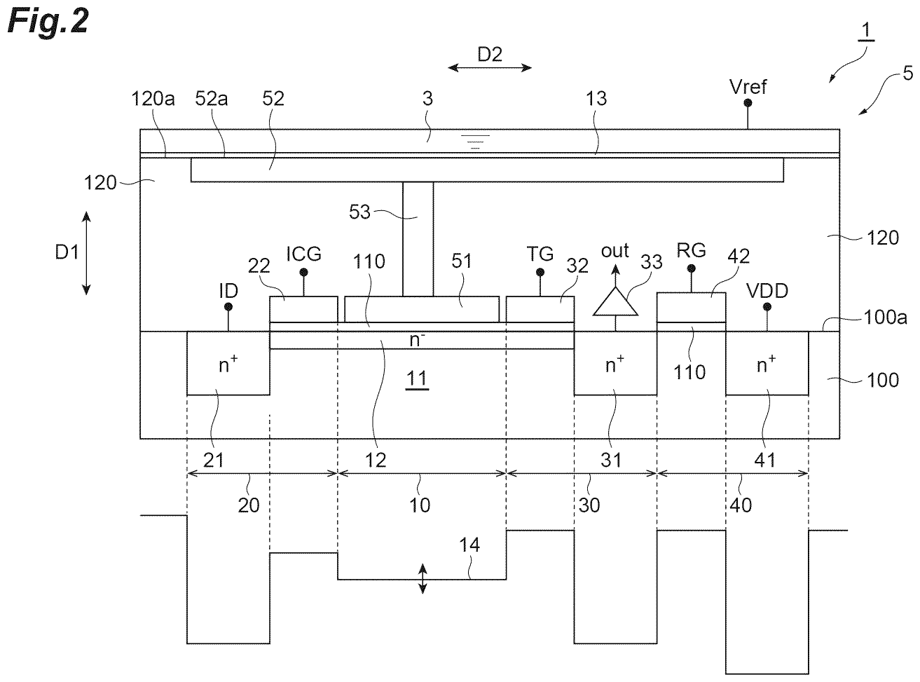

FIG. 1 is a schematic plan view of an ion sensor 1 of a first embodiment. The right part of FIG. 1 schematically shows a layout example common to each detection unit 5. FIG. 2 is a diagram schematically showing a cross-sectional configuration of the detection unit 5 taken along line II-II in FIG. 1. As shown in FIG. 2, the ion sensor 1 is a sensor device configured to be able to detect an ion concentration of a test object (not shown) brought into contact with an aqueous solution 3 (medium) by immersing the surface of the ion sensor 1 in the aqueous solution 3. The test object may be in a solid state, a liquid state, or a gas state.

The ion sensor 1 is a sensor in which a plurality of detection units 5 arranged two-dimensionally are formed on a substrate 100. The ion sensor 1 is a so-called charge transfer type CMOS image sensor. The plurality of detection units 5 are two-dimensionally arranged in a pixel formation region R provided on a chip of the ion sensor 1 (in the present embodiment, a rectangular region provided in the central portion of the chip) in M rows and N columns (for example, 256 rows and 256 columns) to form a pixel array. M and N are each an integer of 2 or more. One detection unit 5 corresponds to one detection unit (pixel). The size (pixel size) of one detection unit 5 is, for example, 15 μm×15 μm.

The aqueous solution 3 is dropped onto the surfaces of a plurality of the detection units 5 included in the pixel formation region R during measurement. Thus, as shown in FIG. 2, the surface of each detection unit 5 is covered with the aqueous solution 3 during the measurement. The aqueous solution 3 is, for example, an SSC solution, a pH standard solution, a culture solution of cells, or the like. At the time of measurement, a reference voltage Vref is applied to the aqueous solution 3 by an electrode (not shown). The electrode used to apply the reference voltage Vref may be, for example, an external electrode such as a glass electrode or may be an electrode incorporated in the ion sensor 1 (for example, an electrode embedded in the passivation layer 120 and electrically connected to the aqueous solution 3 through an opening provided in the passivation layer 120). The electrode may be formed of a material capable of applying a voltage by coming into contact with the aqueous solution 3.

As shown in FIGS. 1 and 2, each detection unit 5 is formed on one main surface 100a (first surface) side of the substrate 100. The substrate 100 is a first conductive type (for example, p-type) semiconductor substrate formed of, for example, silicon. In each detection unit 5, an input diode portion 21 (hereinafter referred to as “ID portion 21”) (charge storage portion), a floating diffusion portion 31 (hereinafter referred to as “FD portion 31”), and a reset drain portion 41 (hereinafter referred to as “RD portion 41”) which are second conductive type regions are formed in a region along the main surface 100a of the substrate 100. A first conductive type (for example, p-type) diffusion layer 11 is formed between the ID portion 21 and the FD portion 31 of the substrate 100. A first conductive type region 12 doped in a first conductive type is formed on a surface of the diffusion layer 11.

On the main surface 100a of the substrate 100, an input control gate electrode 22 (hereinafter referred to as an “ICG electrode 22”) (first electrode), a transfer gate electrode 32 (hereinafter referred to as a “TG electrode 32”) (second electrode), a reset gate electrode 42 (hereinafter referred to as an “RG electrode 42”), and a sensing gate electrode 51 (hereinafter referred to as an “SG electrode 51”) (third electrode) are formed (disposed) via an insulating protective film 110. The protective film 110 is a so-called gate insulating film (gate oxide film). For example, SiO₂ or the like may be used as the protective film 110. The protective film 110 is, for example, a thin film about 10 nm thick. On the main surface 100a of the substrate 100, an amplifier (signal amplifier) 33 that amplifies an out signal corresponding to the amount of charges accumulated in the FD portion 31 and an output circuit 34 that is a source follower circuit that outputs the out signal amplified by the amplifier 33 are provided.

The SG electrode 51 is disposed between the ICG electrode 22 and the TG electrode 32 on the main surface 100a so as to overlap with the first conductive type region 12 when viewed in the thickness direction D1 (see FIG. 2) of the substrate 100. In addition, an insulating passivation layer 120 is formed on the main surface 100a so as to cover each of the electrodes (the ICG electrode 22, the TG electrode 32, the RG electrode 42, the SG electrode 51, or the like) provided on the main surface 100a. SiO₂ may be used as the passivation layer 120, for example. Alternatively, Si₃N₄ may be used as the passivation layer 120.

A flat plate-shaped electrode pad 52 (fourth electrode) is provided on a surface 120a of the passivation layer 120 on a side opposite to the substrate 100 side. That is, the electrode pad 52 is disposed on the opposite side of the SG electrode 51 from the substrate 100. The electrode pad 52 is electrically connected to the SG electrode 51. In the present embodiment, the electrode pad 52 is electrically connected to the SG electrode 51 via a metal wiring 53 embedded in an opening (contact hole) formed in the passivation layer 120. In the example shown in FIG. 2, the electrode pad 52 is embedded in the passivation layer 120, and the surface 52a of the electrode pad 52 on a side opposite to the substrate 100 side is flush with the surface 120a of the passivation layer 120. However, the electrode pad 52 may be disposed on the passivation layer 120. In this case, the height position of the surface 52a of the electrode pad 52 is farther from the substrate 100 than the height position of the surface 120a of the passivation layer 120 by the thickness of the electrode pad 52.

An ion sensitive film 13 formed in a thin film is provided on the surface 52a of the electrode pad 52. The ion sensitive film 13 has a property of changing an electric potential (membrane potential) in accordance with a change in an ion concentration of a medium (in the present embodiment, the aqueous solution 3 immersed in the surface of the ion sensor 1) in contact with the ion sensitive film 13. For example, Si₃N₄ or the like may be used as the ion sensitive film 13. The thickness of the ion sensitive film 13 is, for example, about 100 nm. The width of the ion sensitive film 13 in the facing direction D2 in which the ICG electrode 22 and the TG electrode 32 face each other is greater than a separation width between the ICG electrode 22 and the TG electrode 32. The surface 52a of the electrode pad 52 is a flat surface, and the ion sensitive film 13 is formed in a flat shape along the surface 52a of the electrode pad 52. Here, the “flat surface” means a surface which is not provided with an opening or the like in an opening type structure which will be described later and is formed so as to be substantially flat in a macroscopic view. Therefore, for example, the “flat surface” also includes a surface 52a on which a fine uneven structure (for example, an uneven structure having a height sufficiently smaller than that of the medium (aqueous solution 3) to be measured) is provided in order to increase a contact area and improve adhesion between the surface 52a of the electrode pad 52 and the ion sensitive film 13. In addition, as shown in FIG. 2, the ion sensitive film 13 is disposed to the outside of the electrode pad 52. That is, the ion sensitive film 13 has a portion protruding to the outside of the electrode pad 52 when viewed in the thickness direction D1. The portion of the ion sensitive film 13 protruding outside the electrode pad 52 does not contribute to the sensitivity of the ion sensor 1, but serves to prevent the surface 52a of the electrode pad 52 from being exposed to the outside. Accordingly, for example, it is possible to suitably suppress the aqueous solution 3 from infiltrating into the surface 52a of the electrode pad 52.

Next, a functional configuration and an operation principle of the detection unit 5 will be described. The detection unit 5 includes a sensing section 10, a supply section 20, a movement and accumulation section 30, and a removal section 40. In this embodiment, the charges are electrons.

The sensing section 10 is a region facing the SG electrode 51 in the substrate 100. More specifically, the sensing section 10 is a region in which the SG electrode 51 faces the first conductive type region 12 via the protective film 110 between the ICG electrode 22 and the TG electrode 32. That is, the sensing section 10 is a sensing region formed by stacking the diffusion layer 11, the first conductive type region 12, the protective film 110, and the SG electrode 51. When a stimulus is applied to the aqueous solution 3 or the test object itself in order to test the test object (measure the ion concentration), the ion concentration of the aqueous solution 3 changes in accordance with the state of the test object. The stimulus includes, for example, simply bringing the test object into contact with the aqueous solution 3, or applying a physical, chemical, or pharmaceutical stimulus to the aqueous solution 3 or the test object in a state in which the test object is in contact with the aqueous solution 3. Then, in the ion sensitive film 13, a potential change in accordance with a change in ion concentration of the aqueous solution 3 occurs. The potential change of the ion sensitive film 13 is transmitted to the first conductive type region 12 via the electrode pad 52, the metal wiring 53, and the SG electrode 51. As a result, the depth of the potential well 14 formed in the portion (sensing section 10) of the substrate 100 overlapping with the SG electrode 51 when viewed in the thickness direction D1 changes.

The supply section 20 includes the ID portion 21 and the ICG electrode 22 described above. The ID portion 21 is a portion for accumulating charges to be injected into the potential well 14. The ICG electrode 22 controls the amount of charges injected from the ID portion 21 into the potential well 14.

The movement and accumulation section 30 includes the TG electrode 32 and the FD portion 31. The TG electrode 32 is a portion that performs control for transferring charges from the potential well 14 to the FD portion 31 (outside). The FD portion 31 is a portion that accumulates charges transferred from the potential well 14. More specifically, by changing the voltage of the TG electrode 32, it is possible to change the potential of a region (hereinafter referred to as “TG region”) of the substrate 100 facing the TG electrode 32, to transfer the charges filled in the potential well 14 to the FD portion 31, and to accumulate the charges in the FD portion 31.

The removal section 40 includes the RG electrode 42 and the RD portion 41. The removal section 40 is a portion for resetting (removing) the charges accumulated in the FD portion 31. More specifically, by changing the voltage of the RG electrode 42, it is possible to change the potential of a region (hereinafter referred to as an “RG region”) of the substrate 100 facing the RG electrode 42 and discharge the charges accumulated in the FD portion 31 to the RD portion 41 (VDD).

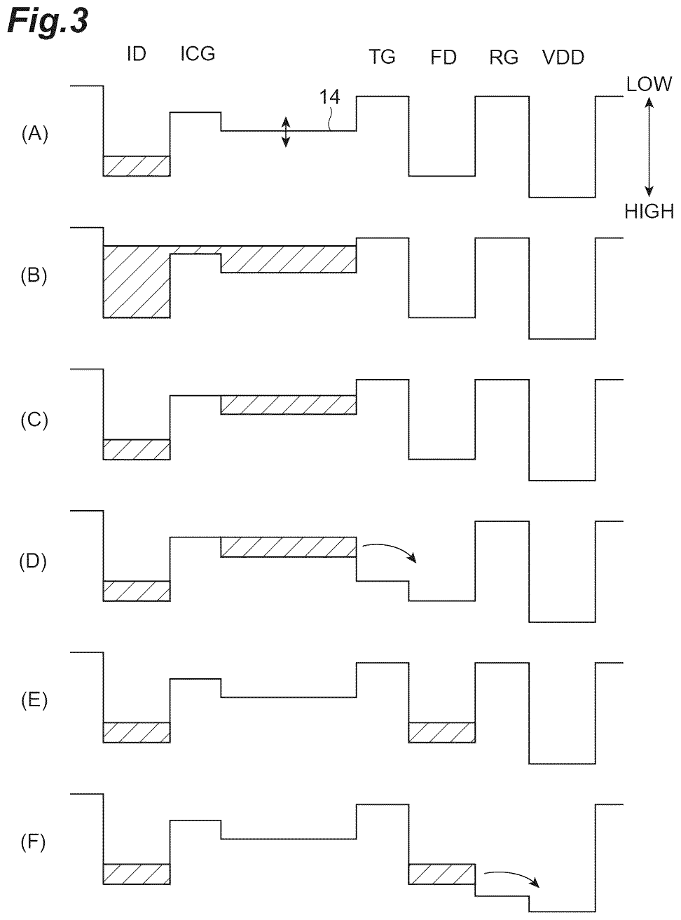

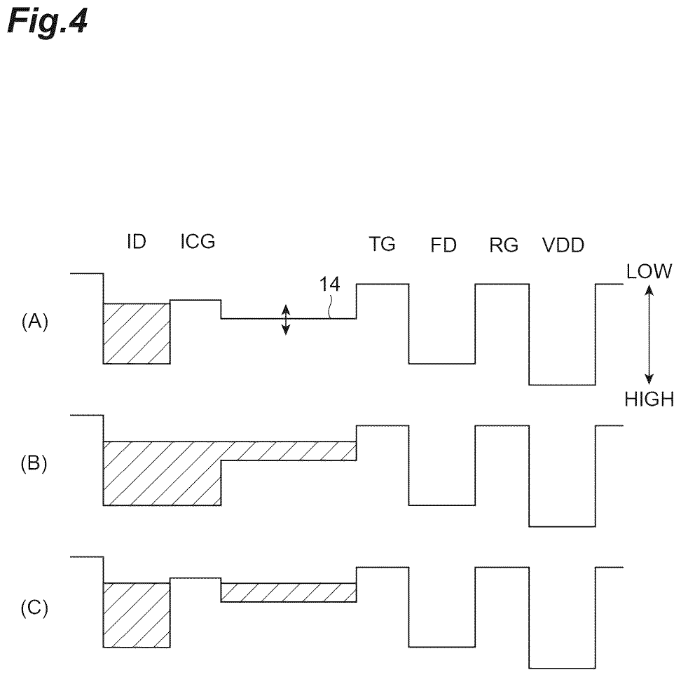

Next, an operation example of the detection unit 5 will be described. FIG. 3 illustrates an operation example of a method (hereinafter, referred to as an “ID driving method”) in which charges are injected from the ID portion 21 into the potential well 14 by changing the potential of the ID portion 21 in a state where the potential of the ICG electrode 22 is constant. FIG. 4 illustrates an operation example of a method (hereinafter, referred to as an “ICG driving method”) in which charges are injected from the ID portion 21 into the potential well 14 by changing the potential of the ICG electrode 22 in a state where the potential of the ID portion 21 is constant.

(ID Driving Method)

The ID driving method will be described with reference to FIG. 3. First, when the stimulus is applied to the aqueous solution 3 or the test object to cause a change in ion concentration of the aqueous solution 3, a potential change of the ion sensitive film 13 in contact with the aqueous solution 3 occurs, and the potential change of the ion sensitive film 13 is transmitted to the diffusion layer 11 (first conductive type region 12) through the electrode pad 52, the metal wiring 53, and the SG electrode 51. As a result, as shown in (A) of FIG. 3 the depth of the potential well 14 changes in accordance with the potential change of the ion sensitive film 13.

Subsequently, as shown in (B) of FIG. 3, the potential of the ID portion 21 is lowered, whereby charges are accumulated in the ID portion 21. The charges accumulated in the ID portion 21 are injected into the potential well 14 beyond a region (hereinafter referred to as an “ICG region”) of the substrate 100 facing the ICG electrode 22. At this time, the potential of the TG region is controlled to be lower than the potential of the ID portion 21. Therefore, the charges injected into the potential well 14 do not exceed the TG region and reach the FD portion 31.

Subsequently, as shown in (C) of FIG. 3, the potential of the ID portion 21 is returned (raised) to the original state, so that the charges are extracted from the ID portion 21. As a result, the charges cut off at the preset potential level of the ICG region remain in the potential well 14. The amount of charges left in the potential well 14 corresponds to the depth of the potential well 14.

Subsequently, as shown in (D) of FIG. 3, the voltage of the TG electrode 32 is raised to transfer the charges left in the potential well 14 to the FD portion 31. Thereafter, the voltage of the TG electrode 32 is returned to the original state, so that the state shown in (E) of FIG. 3 is obtained. In this state, an out signal corresponding to the amount of charges accumulated in the FD portion 31 is output to a measurement unit (not shown) via the amplifier 33 and the output circuit 34. Accordingly, in the measurement unit, the ion concentration of the test object is detected based on the amount of change from the reference potential of the out signal. Subsequently, as shown in (F) of FIG. 3, the charges accumulated in the FD portion 31 are discharged to the RD portion 41 by the voltage of the RG electrode 42 being raised. The RD portion 41 is connected to a VDD power supply. As a result, in the RD portion 41, negatively charged charges are absorbed.

The above-described operations in (B) to (E) of FIG. 3 may be repeated a plurality of times. As a result, the amount of charges accumulated in the FD portion 31 can be increased, and the out signal can be amplified by the number of repetitions. In addition, the amplifier 33 may be omitted by amplifying the out signal through such a repetitive operation. It is possible to improve resolution by repeating the operations (B) to (E) of FIG. 3 (cumulative operation).

(ICG Driving Method)

Next, the ICG driving method will be described with reference to FIG. 4. In the ICG driving method, the operations (A) to (C) in FIG. 3 are replaced with the operations (A) to (C) in FIG. 4. First, as shown in (A) of FIG. 4, the potential of the ID portion 21 is set to a constant value lower than the potential of the potential well 14 and higher than the potential of the TG region. On the other hand, the potential of the ICG region is made lower than the potential of the ID portion 21. Subsequently, as shown in (B) of FIG. 4, by making the potential of the ICG region higher than the potential of the potential well 14, charges are supplied from the ID portion 21 to the potential well 14. Subsequently, as shown in (C) of FIG. 4, by making the potential of the ICG region lower than the potential of the ID portion 21 again, charges up to the level of the potential of the ID portion 21 set in advance remain in the potential well 14. As a result, charges having the same potential as that of the ID portion 21 are accumulated in the potential well 14. The subsequent operations in the ICG driving method are the same as the operations in (D) to (F) of FIG. 3.

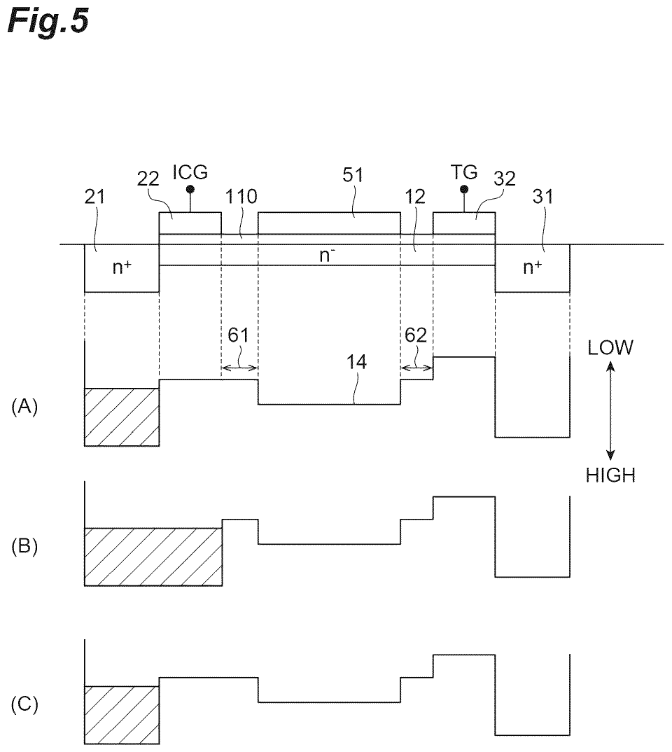

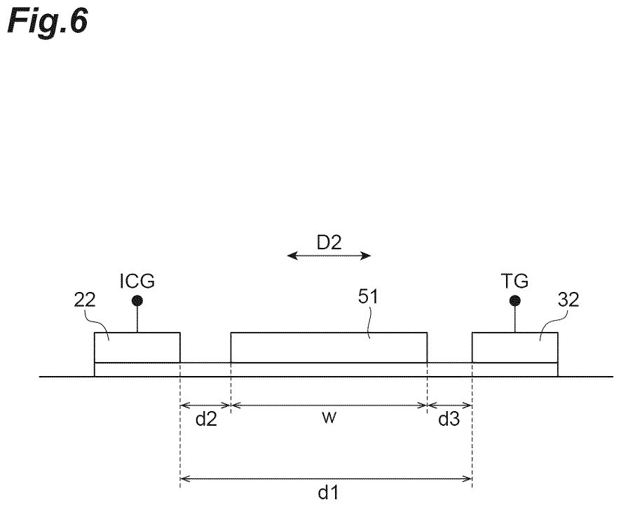

Next, the arrangement (positional relationship) of the ICG electrode 22, the TG electrode 32, and the SG electrode 51 will be described with reference to FIGS. 5 and 6. The ICG electrode 22, the TG electrode 32, and the SG electrode 51 need to be insulated from each other. Therefore, as shown in FIG. 5, the ICG electrode 22 and the SG electrode 51 are disposed so as to be separated from each other. Similarly, the TG electrode 32 and the SG electrode 51 are disposed so as to be separated from each other.

(A) to (C) of FIG. 5 correspond to (A) to (C) of FIG. 4 (ICG driving method). Here, when the separation width between the ICG electrode 22 and the SG electrode 51 is greater than or equal to a certain value, there is a possibility that a potential barrier 61 that inhibits the injection of charges from the ID portion 21 to the potential well 14 may occur. That is, even if the voltage of the ICG electrode 22 is controlled so that the potential of the ICG region becomes higher than the potential of the potential well 14, as illustrated in (B) of FIG. 5, a potential barrier 61 which is maintained at a potential lower than the potential of the potential well 14 may be generated in the region between the ICG electrode 22 and the SG electrode 51. When the potential barrier 61 is generated, the injection of charges from the ID portion 21 to the potential well 14 is blocked by the potential barrier 61, and the charge transfer efficiency from the ID portion 21 to the potential well 14 is deteriorated.

Similarly, when the separation width between the TG electrode 32 and the SG electrode 51 is greater than or equal to a certain value, there is a possibility that a potential barrier 62 that inhibits the transfer of charges from the potential well 14 to the FD portion 31 may occur. That is, as shown in (D) of FIG. 3, even if the voltage of the TG electrode 32 is controlled so that the potential of the TG region becomes higher than the potential of the potential well 14, a potential barrier 62 which is maintained at a potential lower than the potential of the potential well 14 may be generated in the region between the TG electrode 32 and the SG electrode 51. When the potential barrier 62 is generated, the injection of charges from the potential well 14 to the FD portion 31 is blocked by the potential barrier 62, and the charge transfer efficiency from the potential well 14 to the FD portion 31 is deteriorated.

Therefore, in the ion sensor 1, a separation width d2 (first separation width) (see FIG. 6) between the ICG electrode 22 and the SG electrode 51 is set so that the potential barrier 61 is not generated. Here, the condition (upper limit value) of the separation width d2 for not generating the potential barrier 61 to such an extent that injection of charges from the ID portion 21 to the potential well 14 is inhibited depends on the magnitude of the voltage applied to the ICG electrode 22, the thickness of the protective film 110, the impurity concentration of the first conductive type region 12, or the like. More specifically, as the voltage applied to the ICG electrode 22 increases, the upper limit value of the separation width d2 increases. The thicker the protective film 110 is, the greater the upper limit of the separation width d2 is. However, in this case, it is necessary to increase the voltage applied to the ICG electrode 22 by an amount corresponding to the increase in the thickness of the protective film 110. In addition, as the impurity concentration of the first conductive type region 12 increases (becomes denser), the upper limit value of the separation width d2 decreases. The upper limit value of the separation width d2 is calculated by performing experiments, simulations, or the like using parameters such as the voltage applied to the ICG electrode 22, the thickness of the protective film 110, and the impurity concentration of the first conductive type region 12. In the ion sensor 1, the upper limit value of the separation width d2 for not generating the potential barrier 61 is calculated based on the voltage applied to the ICG electrode 22, the thickness of the protective film 110, and the impurity concentration of the first conductive type region 12, and the separation width d2 is set within a range not exceeding the calculated upper limit value. Thus, sufficient charge transfer efficiency from the ID portion 21 to the potential well 14 is secured.

Similarly, a separation width d3 (second separation width) (see FIG. 6) between the TG electrode 32 and the SG electrode 51 is set so that the potential barrier 62 is not generated. Here, the condition (upper limit value) of the separation width d3 for not generating the potential barrier 62 to such an extent that the transfer of charges from the potential well 14 to the FD portion 31 is inhibited depends on the magnitude of the voltage applied to the TG electrode 32, the thickness of the protective film 110, the impurity concentration of the first conductive type region 12, or the like. More specifically, as the voltage applied to the TG electrode 32 increases, the upper limit value of the separation width d2 increases. The thicker the protective film 110 is, the greater the upper limit of the separation width d3 is. However, in this case, it is necessary to increase the voltage applied to the TG electrode 32 by an amount corresponding to the increase in the thickness of the protective film 110. In addition, as the impurity concentration of the first conductive type region 12 increases (becomes denser), the upper limit value of the separation width d3 decreases. The upper limit value of the separation width d2 is calculated by performing experiments, simulations, or the like using parameters such as the voltage applied to the TG electrode 32, the thickness of the protective film 110, and the impurity concentration of the first conductive type region 12. In the ion sensor 1, the upper limit value of the separation width d3 for not generating the potential barrier 62 is calculated based on the voltage applied to the electrode 32, the thickness of the protective film 110, and the impurity concentration of the first conductive type region 12, and the separation width d3 is set within a range not exceeding the calculated upper limit value. Thus, sufficient charge transfer efficiency from the potential well 14 to the FD portion 31 is secured.

As an example, the width w (see FIG. 6) of the SG electrode 51 in the facing direction D2 is 80% or more of the separation width d1 (see FIG. 6) between the ICG electrode 22 and the TG electrode 32. That is, each of the separation width d2 between the ICG electrode 22 and the SG electrode 51 and the separation width d3 between the TG electrode 32 and the SG electrode 51 is set to be about 10% or less of the separation width d1 between the ICG electrode 22 and the TG electrode 32. In this manner, by setting the arrangement and dimensions of the ICG electrode 22, the TG electrode 32, and the SG electrode 51, it is possible to suitably suppress the occurrence of the potential barriers 61 and 62 under general conditions related to the applied voltage to the ICG electrode 22 and the TG electrode 32, the thickness of the protective film 110, the impurity concentration of the first conductive type region 12, or the like.

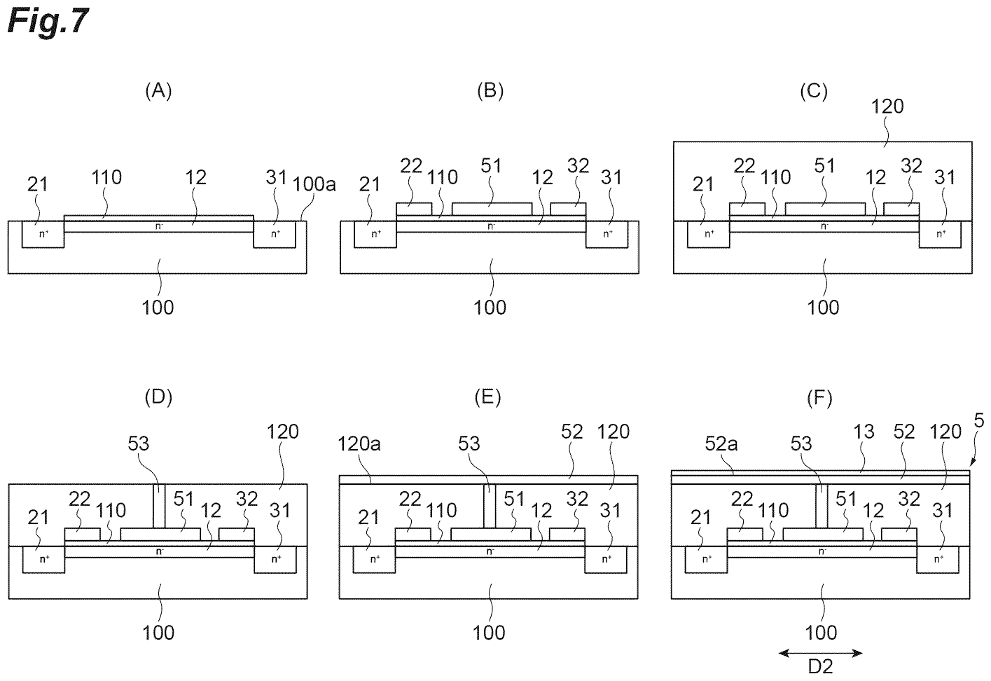

Next, an example of a method of manufacturing the ion sensor 1 will be described with reference to FIG. 7. Here, a description will be given focusing on a manufacturing process of portions related to the ICG electrode 22, the TG electrode 32, and the SG electrode 51 in each pixel (each detection unit 5).

First, as shown in (A) of FIG. 7, the substrate 100 is prepared, and the protective film 110 (first insulating film) as a gate oxide film is formed on the main surface 100a of the substrate 100. The protective film 110 is formed between the ID portion 21 and the FD portion 31 in a region where at least the ICG electrode 22, the TG electrode 32, and the SG electrode 51 are to be disposed.

Subsequently, as illustrated in (B) of FIG. 7, the ICG electrode 22, the TG electrode 32, and the SG electrode 51 are formed on the protective film 110. The ICG electrode 22, the TG electrode 32, and the SG electrode 51 are formed of, for example, polysilicon. The TG electrode 32 is disposed so as to be separated from the ICG electrode 22. The SG electrode 51 is disposed between the ICG electrode 22 and the TG electrode 32 so as to be spaced apart from both the ICG electrode 22 and the TG electrode 32.

Subsequently, as shown in (C) of FIG. 7, the passivation layer 120 (second insulating film) covering the ICG electrode 22, the TG electrode 32, and the SG electrode 51 is formed on the main surface 100a of the substrate 100. Subsequently, as shown in (D) of FIG. 7, an opening (contact hole) is formed in the passivation layer 120 so as to expose a portion of the SG electrode 51, and a metal wiring 53 electrically connected to the SG electrode 51 is formed (buried) in the opening.

Subsequently, as shown in (E) of FIG. 7, the electrode pad 52 electrically connected to the metal wiring 53 is formed in a flat plate shape along the surface 120a of the passivation layer 120. Subsequently, as shown in (F) of FIG. 7, the ion sensitive film 13 is formed on the surface 52a of the electrode pad 52. Here, the ion sensitive film 13 is formed such that the width of the ion sensitive film 13 in the facing direction D2 is greater than the separation width between the ICG electrode 22 and the TG electrode 32. Thus, the above-described pixel structure (detection unit 5) is obtained. In (F) of FIG. 7, since only a part of the detection unit 5 is illustrated, the width of the ion sensitive film 13 is equal to the width of the electrode pad 52, but the ion sensitive film 13 may be formed to the outside of the electrode pad 52. More specifically, in the manufacturing method, when the electrode pad 52 is formed on the passivation layer 120, the surface 52a and side surfaces of the electrode pad 52 are exposed. Therefore, the ion sensitive film 13 may be formed so as to cover the surface 52a and side surfaces of the electrode pad 52 and a portion of the passivation layer 120 outside the electrode pad 52. According to the ion sensitive film 13 formed in this manner, it is possible to prevent the surface 52a and the side surfaces of the electrode pad 52 from being exposed to the outside, and it is possible to suitably suppress the infiltration of the aqueous solution 3 into the surface 52a of the electrode pad 52.

In the ion sensor 1 described above, the SG electrode 51 is disposed between the ICG electrode 22 and the TG electrode 32 on the main surface 100a of the substrate 100. The SG electrode 51 is electrically connected to the electrode pad 52 provided with the ion sensitive film 13. Thus, the function as the ion sensor 1 is realized. More specifically, a change in the potential of the ion sensitive film 13 can be transmitted to the substrate 100 (more specifically, a region overlapping with the SG electrode 51 when viewed in the thickness direction D1 in a region along the main surface 100a of the substrate 100) via the electrode pad 52 and the SG electrode 51. This makes it possible to change the depth of the potential well 14 in accordance with a change in the potential of the ion sensitive film 13. As a result, it is possible to detect the ion concentration of the test object brought into contact with the medium (aqueous solution 3 in the present embodiment) in contact with the ion sensitive film 13 based on the amount (that is, the amount corresponding to the depth of the potential well 14) of charges taken out to the outside (FD portion 31) by the control (voltage control) of the ICG electrode 22 and the TG electrode 32.

Here, if a configuration (opening type structure) in which an opening (a concave portion in which a passivation layer is not formed) is provided between the ICG electrode 22 and the TG electrode 32 and an ion sensitive film is provided at the bottom of the opening is adopted, the width of the ion sensitive film is limited by the size of the opening, and the width of the ion sensitive film cannot be made larger than the separation width between the ICG electrode 22 and the TG electrode 32. On the other hand, the ion sensor 1 adopts a configuration in which the potential change of the ion sensitive film 13 is transmitted to the substrate 100 through the SG electrode 51 and the electrode pad 52, thereby realizing a configuration in which the ion sensitive film 13 is wider than the separation width between the ICG electrode 22 and the TG electrode 32. Accordingly, the contact area between the ion sensitive film 13 and the aqueous solution 3 may be sufficiently secured, and the sensitivity of the ion sensor 1 may be effectively improved.

In addition, in the ion sensor 1, the SG electrode 51 is disposed directly above the substrate 100 via only the extremely thin (10 nm in the present embodiment) protective film 110, and thus a structure in which an electric field is easily transmitted from the bottom surface (surface on the protective film 110 side) of the SG electrode 51 to the substrate 100 (a structure in which a channel is easily formed) is realized. As a result, it is possible to eliminate the need for injection of depletion for facilitating formation of the channel in the substrate 100 (that is, formation of the first conductive type region 12), which is required in the above-described opening type structure. That is, in the ion sensor 1, the first conductive type region 12 may be omitted. Accordingly, a negative voltage required for injection of the depletion (i.e., a negative voltage for turning off the channel in the region immediately below the ICG electrode 22, the TG electrode 32, and the RG electrode 42 in the substrate 100) can be made unnecessary.

The surface 52a of the electrode pad 52 is a flat surface, and the ion sensitive film 13 is formed in a flat shape along the surface 52a. According to the above-described configuration, the medium (aqueous solution 3) disposed on the ion sensitive film 13 and the ion sensitive film 13 can be sufficiently brought into close contact with each other as compared to a case where the above-described opening type structure is adopted. Accordingly, the sensitivity of the ion sensor 1 can be more effectively improved.

### Second Embodiment

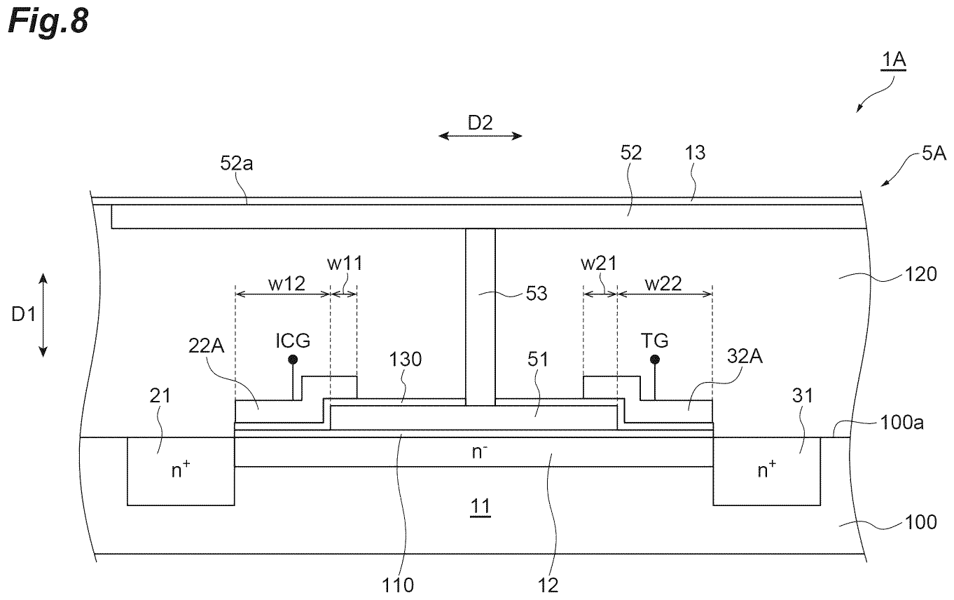

FIG. 8 is a diagram schematically illustrating a cross-sectional configuration of a detection unit 5A of an ion sensor 1A of the second embodiment. The ion sensor 1A is different from the ion sensor 1 in that it has the detection unit 5A instead of the detection unit 5 (see FIG. 2) as a pixel structure, and other configurations of the ion sensor 1A are the same as those of the ion sensor 1. The detection unit 5A is different from the detection unit 5 mainly in that the detection unit 5A includes an ICG electrode 22A and a TG electrode 32A instead of the ICG electrode 22 and the TG electrode 32.

As shown in FIG. 8, when viewed in the thickness direction D1, a portion of the ICG electrode 22A overlaps with the SG electrode 51. In the present embodiment, in order to insulate the ICG electrode 22A and the SG electrode 51 from each other, a protective film 130 that covers the upper surface (surface on the side opposite to the protective film 110 side) and the side surface of the SG electrode 51 is formed. That is, a portion of the ICG electrode 22A is in contact with the SG electrode 51 via the protective film 130. The protective film 130 may be formed of the same material (for example, SiO₂) as the protective film 110, for example. The thickness of the protective film 130 is, for example, about 50 nm.

A width w11 in the facing direction D2 of a portion (first portion) of the ICG electrode 22A that overlaps with the SG electrode 51 is smaller than a width w12 in the facing direction D2 of a portion (second portion) of the ICG electrode 22A that does not overlap with the SG electrode 51. This is due to the following reason. That is, when the width w12 of the second portion is not sufficient, the ICG region does not sufficiently function as a gate region that controls the flow of charges between the ID portion 21 and the potential well 14, and leakage of charges from the potential well 14 to the ID portion 21 may occur. Therefore, the ICG electrode 22A overlaps with the SG electrode 51 so that “w11<w12” is satisfied. More preferably, the ICG electrode 22A overlaps with the SG electrode 51 such that the width w11 of the first portion is smaller than or equal to 25% of the width w12 of the second portion (i.e., such that “w11≤0.25×w12” is satisfied). According to the above configuration, it is possible to suitably suppress unintended leakage of charges from the potential well 14 to the ID portion 21.

When viewed in the thickness direction D1, a portion of the TG electrode 32A overlaps with the SG electrode 51. In the present embodiment, a portion of the TG electrode 32A is in contact with the SG electrode 51 via the protective film 130 described above. A width w21 in the facing direction D2 of a portion (third portion) of the TG electrode 32A that overlaps with the SG electrode 51 is smaller than a width w22 in the facing direction D2 of a portion (fourth portion) of the TG electrode 32A that does not overlap with the SG electrode 51. This is due to the following reason. That is, when the width w22 of the fourth portion is not sufficient, the TG region does not sufficiently function as a gate region that controls the flow of charges between the potential well 14 and the FD portion 31, and leakage of charges from the potential well 14 to the FD portion 31 may occur. Therefore, the TG electrode 32A overlaps with the SG electrode 51 so that “w21<w22” is satisfied. More preferably, the TG electrode 32A overlaps with the SG electrode 51 such that the width w21 of the third portion is smaller than or equal to 25% of the width w22 of the fourth portion (i.e., such that “w21≤0.25×w22” is satisfied). According to the above configuration, it is possible to suitably suppress unintended leakage of charges from the potential well 14 to the FD portion 31.

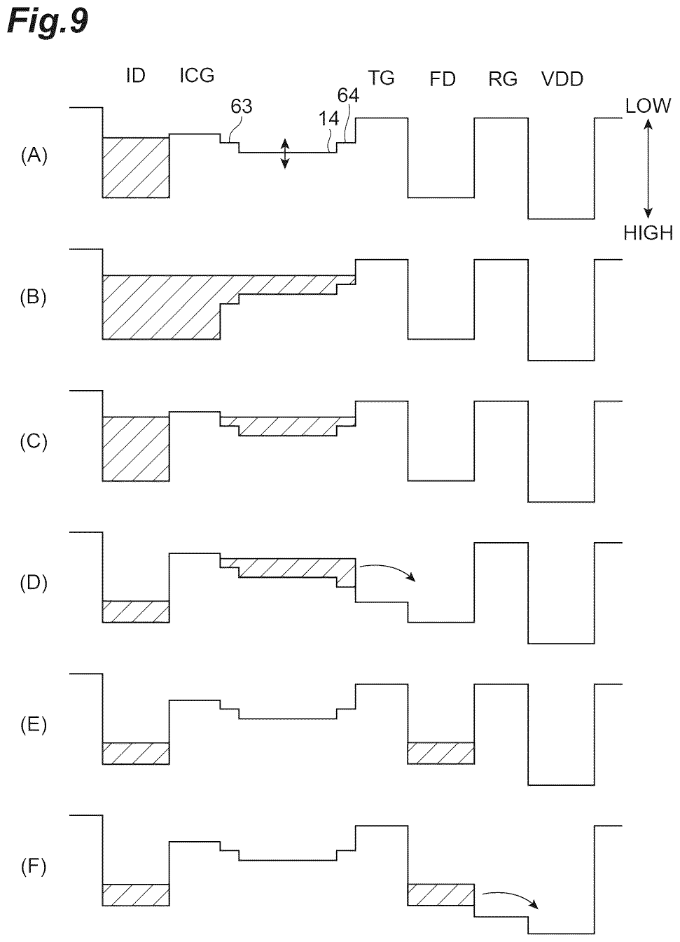

With reference to FIG. 9, an effect obtained by the pixel structure (detection unit 5A) of the ion sensor 1A will be further described. (A) to (F) of FIG. 9 show each step of the operation of the detection unit 5A in the ICG driving method. As described above, a portion in which the ICG electrode 22A and the SG electrode 51 overlap with each other is formed in the detection unit 5A. As a result, a region 63 having a potential between the potential of the ICG region and the potential of the potential well 14 is formed in a portion of the substrate 100 where the ICG electrode 22A and the SG electrode 51 overlap with each other. By forming such a region 63, the following effects are exhibited. If the region 63 is not formed (that is, if the potential of the ICG region is flat), it is uncertain whether the charges of the ICG region move to the ID portion 21 or move to the potential well 14 when the potential of the ICG region is made lower than the potential of the ID portion 21 (that is, when the state of (B) of FIG. 9 transitions to the state of (C) of FIG. 9). For this reason, variation (noise) may occur in the amount of charges moving to the potential well 14 side (that is, the amount of charges accumulated in the potential well 14) among the charges in the ICG region. In contrast, in the case where the region 63 is formed, when the potential of the ICG region is made lower than the potential of the ID portion 21, it is possible to generate a potential difference from the ID portion 21 to the potential well 14 in a step-like shape (substantially slope shape), and thus it is possible to smoothly move the charges of the ICG region to the potential well 14 side. As a result, it is possible to reduce variations in the amount of charges accumulated in the potential well 14.

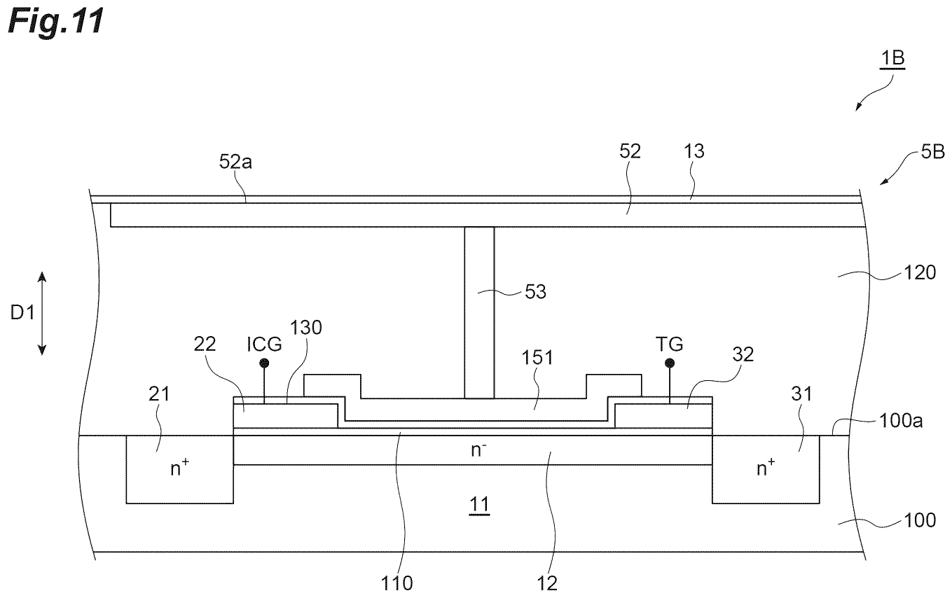

In addition, a portion (the first portion) of the ICG electrode 22A is disposed on the opposite side of the SG electrode 51 from the substrate 100. That is, the edge portion of the SG electrode 51 is disposed between the ICG electrode 22A and the substrate 100. According to the above-described configuration, it is possible to lower a voltage value necessary for forming the potential well 14 in a region overlapping with the SG electrode 51 in the substrate 100, compared to a case where a portion of the ICG electrode 22A is disposed between the substrate 100 and the SG electrode 51 (an ion sensor 1B of a third embodiment described later). More specifically, in an ion sensor 1B (see FIG. 11) to be described later, the protective film 110 and the protective film 130 are formed between the SG electrode 151 and the substrate 100, whereas in the ion sensor 1A, only the protective film 110 is formed between the SG electrode 51 and the substrate 100. That is, in the ion sensor 1A, the distance between the SG electrode 51 and the substrate 100 is smaller than that in the ion sensor 1B by the amount of the protective film 130. Thus, the above-described effect (reduction of the necessary voltage value) is achieved.

Further, in the detection unit 5A, a portion where the TG electrode 32A and the SG electrode 51 overlap with each other is formed. As a result, a region 64 having a potential between the potential of the TG region and the potential of the potential well 14 is formed in a portion of the substrate 100 where the TG electrode 32A and the SG electrode 51 overlap with each other. By forming such a region 64, it is possible to improve charge transfer efficiency at the time of charge transfer from the potential well 14 to the FD portion 31 (see (D) of FIG. 9). That is, since it is possible to generate a potential difference from the potential well 14 to the FD portion 31 in a step-like shape (substantially slope shape) by the region 64, it is possible to smoothly transfer charges from the potential well 14 to the FD portion 31.

In addition, a portion (the third portion) of the TG electrode 32A is disposed on the opposite side of the SG electrode 51 form the substrate 100. That is, the edge portion of the SG electrode 51 is disposed between the TG electrode 32A and the substrate 100. According to the above-described configuration, for the same reason as described above, it is possible to lower a voltage value necessary for forming the potential well 14 in a region overlapping with the SG electrode 51 in the substrate 100, compared to a case where a portion of the TG electrode 32A is disposed between the substrate 100 and the SG electrode 51 (an ion sensor 1B of a third embodiment described later).

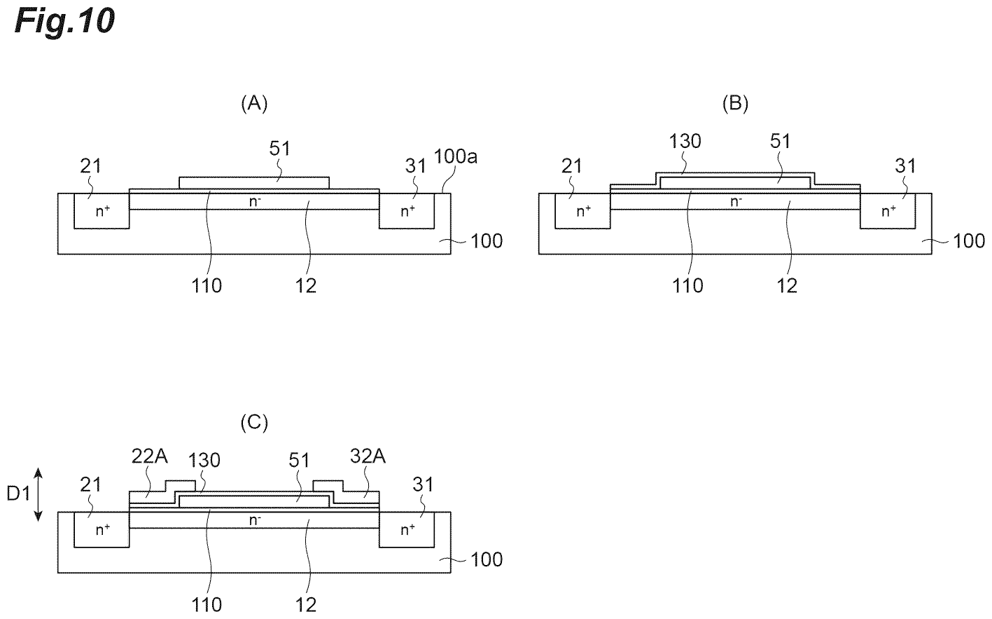

Next, an example of a method of manufacturing the ion sensor 1A will be described with reference to FIG. 10. Here, a description will be given focusing on a manufacturing process of portions related to the ICG electrode 22A, the TG electrode 32A, and the SG electrode 51 in each pixel (each detection unit 5A).

First, as shown in (A) of FIG. 10, the substrate 100 is prepared, and the protective film 110 (first insulating film) as a gate oxide film is formed on the main surface 100a of the substrate 100. The protective film 110 is formed between the ID portion 21 and the FD portion 31 in a region where at least the ICG electrode 22A, the TG electrode 32A, and the SG electrode 51 are to be disposed. Subsequently, the SG electrode 51 is formed on the protective film 110.

Subsequently, as shown in (B) of FIG. 10, the protective film 130 (second insulating film) is formed to cover the surfaces of the SG electrode 51 (at least the surfaces of portions in contact with the ICG electrode 22A and the TG electrode 32A). Subsequently, as shown in (C) of FIG. 10, when viewed in the thickness direction D1, the ICG electrode 22A is formed such that a portion of the ICG electrode 22A overlaps with the SG electrode 51 via the protective film 130. In addition, when viewed in the thickness direction D1, the TG electrode 32A is formed such that a portion of the TG electrode 32A overlaps with the SG electrode 51 via the protective film 130.

Subsequently, steps similar to those of the above-described method of manufacturing the ion sensor 1 (steps corresponding to (C) to (F) of FIG. 7) are performed. That is, the passivation layer 120 (third insulating film) is formed on the main surface 100a of the substrate 100 to cover the ICG electrode 22A, the TG electrode 32A, and the SG electrode 51. Subsequently, an opening (contact hole) is formed in the passivation layer 120 so as to expose a portion of the SG electrode 51, and a metal wiring 53 electrically connected to the SG electrode 51 is formed in the opening. In the present embodiment, since the protective film 130 is formed so as to cover the entire upper surface of the SG electrode 51, an opening is also formed in the protective film 130 in the step of forming an opening in the passivation layer 120 described above (see FIG. 8). Subsequently, the electrode pad 52 electrically connected to the metal wiring 53 is formed in a flat plate shape along the surface 120a of the passivation layer 120. Subsequently, the ion sensitive film 13 is formed on the surface 52a of the electrode pad 52. Here, the ion sensitive film 13 is formed such that a width of the ion sensitive film 13 in the facing direction D2 is greater than a separation width between the ICG electrode 22A and the TG electrode 32A. As described above, the above-described pixel structure (detection unit 5A) is obtained.

According to the ion sensor 1A described above, it is possible to reliably prevent the occurrence of the potential barriers 61 and 62 that may occur when the ICG electrode, the TG electrode, and the SG electrode are disposed apart from each other, and to improve the efficiency of charge transfer from the ID portion 21 to the potential well 14 and charge transfer from the potential well 14 to the FD portion 31, as described above.

### Third Embodiment

FIG. 11 is a diagram schematically illustrating a cross-sectional configuration of a detection unit 5B of an ion sensor 1B of the third embodiment. The ion sensor 1B is different from the ion sensor 1 in that it has the detection unit 5B instead of the detection unit 5 (see FIG. 2) as a pixel structure, and other configurations of the ion sensor 1B are the same as those of the ion sensor 1. The detection unit 5B is different from the detection unit 5 mainly in that the detection unit 5B includes an SG electrode 151 instead of the SG electrode 51.

The detection unit 5B has the same feature as the detection unit 5A in that a portion of the ICG electrode 22 overlaps with the SG electrode 151 and a portion of the TG electrode 32 overlaps with the SG electrode 151 when viewed in the thickness direction D1. However, in the detection unit 5A, a portion of the ICG electrode 22A and a portion of the TG electrode 32A are located above the SG electrode 51 (on the side of the SG electrode 51 opposite to the substrate 100 side), whereas in the detection unit 5B, a portion of the ICG electrode 22 and a portion of the TG electrode 32 are located below the SG electrode 151 (on the substrate 100 side of the SG electrode 51).

The detection unit 5B can be manufactured, for example, as follows. First, the ICG electrode 22 and the TG electrode 32 are formed on the protective film 110. Subsequently, the protective film 130 is formed to cover at least the surface of the ICG electrode 22 (the upper surface and the side surface on the inner side (TG electrode 32 side)) and the surface of the TG electrode 32 (the upper surface and the side surface on the inner side (ICG electrode 22 side)). Subsequently, the SG electrode 151 is formed on the protective film 130 such that, when viewed in the thickness direction D1, a portion of the SG electrode 151 overlaps with a portion of the ICG electrode 22 via the protective film 130 and another portion of the SG electrode 151 overlaps with a portion of the TG electrode 32 via the protective film 130.

The ion sensor 1B described above can also reliably prevent the occurrence of the potential barriers 61 and 62 in the same manner as the ion sensor 1A described above.

[Modification]

Although the preferred embodiments of the present disclosure have been described in detail above, the present disclosure is not limited to the above embodiments. For example, in the ion sensors 1, 1A, and 1B, the plurality of detection units 5, 5A, and 5B may be one-dimensionally arranged. In addition, the substrate 100 is not necessarily a semiconductor substrate, and may be a substrate other than a semiconductor and having a semiconductor region (for example, a semiconductor film or the like) formed on its surface, for example. In addition, the protective film 110 formed between each electrode member and the substrate 100 may be continuously formed. That is, the protective film 110 may be formed on the entire main surface 100a of the substrate 100.

In addition, the medium disposed on the ion sensitive film 13 may be a substance other than the aqueous solution 3 (for example, a substance adsorption film or the like having a property of changing electrical characteristics when a smell substance is adsorbed). Here, the smell substance is a chemical substance that causes the smell (for example, a specific single molecule or a group of molecules aggregated at a predetermined concentration). Examples of the substance adsorption film include a polyaniline sensitive film having sensitivity to ammonia or the like. In this case, the ion sensor 1 functions as a smell sensor that detects the smell. Even when a solid substance adsorption film that does not necessarily adsorb a smell substance is provided as the medium, it is preferable to form the ion sensitive film 13 to the outside of the electrode pad 52 as shown in FIG. 2. In this case, in the process of forming the substance adsorption film on the ion sensitive film 13, it is possible to suitably suppress infiltration of a solvent or the like used for film formation into the surface 52a of the electrode pad 52.

In addition, in the second embodiment and the third embodiment described above, the SG electrode may be disposed so as to overlap with only one of the ICG electrode and the TG electrode, and be separated from the other of the ICG electrode and the TG electrode.

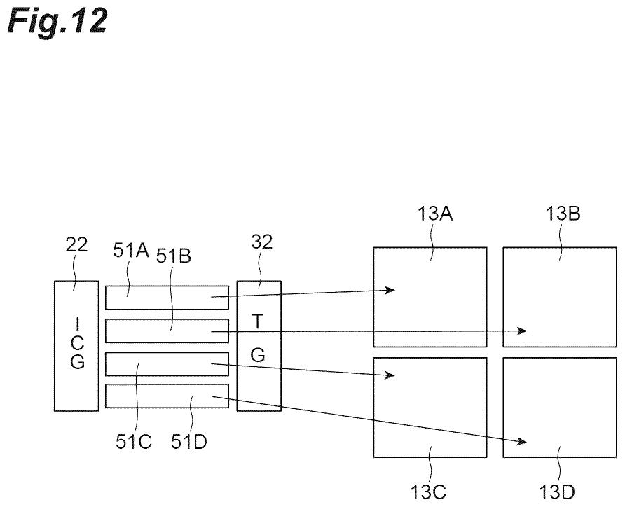

Further, as illustrated in FIG. 12, one detection unit 5, 5A, or 5B (pixel) may include a plurality of (here, four as an example) ion sensitive films 13A, 13B, 13C, 13D that react to ions different from each other. In addition, a plurality of electrode pads 52 may be provided corresponding to each of the plurality of ion sensitive films 13A, 13B, 13C, and 13D. That is, the electrode pad 52 provided with the ion sensitive film 13A, the electrode pad 52 provided with the ion sensitive film 13B, the electrode pad 52 provided with the ion sensitive film 13C, and the electrode pad 52 provided with the ion sensitive film 13D may be provided independently (separately) from each other. The plurality of SG electrodes 51A, 51B, 51C, and 51D may be provided independently (separately) from each other so as to correspond to each of the plurality of electrode pads 52 as described above. According to the above configuration, the amount of information obtained from one pixel can be increased. That is, it is possible to detect the concentrations of a plurality of types of ions by one pixel. Specifically, the total value of the concentrations of a plurality of types of ions can be detected by one pixel. For example, a case is considered in which the ion sensitive film 13A is formed of a material having a property of changing its potential in accordance with ion concentration of first ion, the ion sensitive film 13B is formed of a material having a property of changing its potential in accordance with ion concentration of second ion, the ion sensitive film 13C is formed of a material having a property of changing its potential in accordance with ion concentration of third ion, and the ion sensitive film 13D is formed of a material having a property of changing its potential in accordance with ion concentration of fourth ion. According to the above-described configuration, for example, in a water quality inspection or the like, in a case where it is determined to be OK when first to fourth ion are not included (that is, in a case where it is determined to be NG when at least one of first to fourth ions is included), it is possible to perform the determination using only information obtained from one pixel.

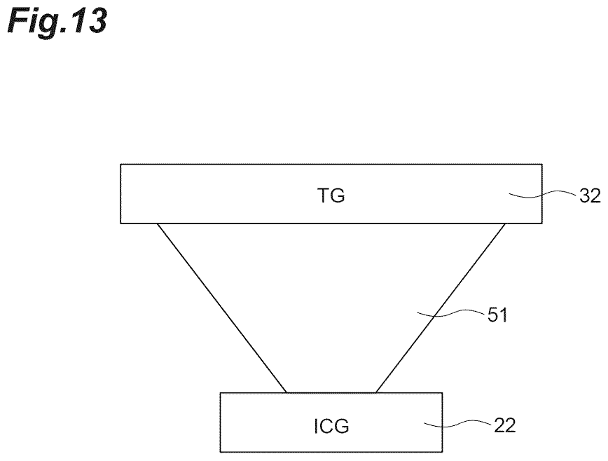

In the above-described embodiment, as shown in FIG. 1, when viewed in the thickness direction D1, the ICG electrode 22 and the TG electrode 32 are formed in a rectangular shape having substantially the same size, and the SG electrode 51 disposed therebetween is formed in a rectangular shape, but the shape and size of each electrode are not limited to the above. For example, in order to improve the charge transfer efficiency from the ID portion 21 to the FD portion 31, as shown in FIG. 13, when viewed in the thickness direction D1, the ICG electrode 22 may be formed in a rectangular shape smaller than the TG electrode 32, and the SG electrode 51 may be formed in a trapezoidal shape that becomes wider from the ICG electrode 22 side toward the TG electrode 32 side.

### REFERENCE SIGNS LIST

1, 1A, 1B Ion sensor
3 Aqueous solution (medium)
5, 5A, 5B Detector (pixel)
13 Ion sensitive film
14 Potential well
21 ID portion (charge storage portion)
22, 22A ICG electrode (first electrode)
31 FD portion (outside)
32, 32A TG electrode (second electrode)
51, 51A, 51B, 51C, 51D, 151 SG electrode (third electrode)
52 Electrode pad (fourth electrode)
53 Metal wiring
61, 62 Potential barrier
100 Substrate
100a Main surface (first surface)
110 Protective film (first insulating film)
120 Passivation layer (second insulating film, third insulating film)
130 Protective film (second insulating film)

1: An ion sensor comprising:
a substrate; and
a plurality of pixels provided on a first surface of the substrate,
wherein each pixel of the plurality of pixels includes a charge storage portion, a first electrode, a second electrode, a third electrode, a fourth electrode, and an ion sensitive film,
the charge storage portion is formed in a region of the substrate along the first surface, and configured to accumulate charges to be injected into a potential well formed in a portion of the substrate overlapping with the third electrode when viewed in a thickness direction of the substrate,
the first electrode is disposed on the first surface, and configured to control an amount of charge injection from the charge storage portion to the potential well,
the second electrode is disposed on the first surface, and is configured to perform control for transferring charges from the potential well to the outside,
the third electrode is disposed between the first electrode and the second electrode on the first surface,
the fourth electrode is electrically connected to the third electrode and is disposed on an opposite side of the third electrode from the substrate,
the ion sensitive film is provided on a surface of the fourth electrode on a side opposite to the substrate side, and configured to change a potential in accordance with a change in ion concentration of a medium in contact with the ion sensitive film, and
a width of the ion sensitive film in a facing direction in which the first electrode and the second electrode face each other is greater than a separation width between the first electrode and the second electrode.

2: The ion sensor according to claim 1, wherein
a surface of the fourth electrode opposite to the substrate side is a flat surface, and
the ion sensitive film is formed in a flat shape along the surface of the fourth electrode.

3: The ion sensor according to claim 1, wherein
the first electrode and the third electrode are spaced apart from each other, and
a first separation width between the first electrode and the third electrode is set in a range in which a potential barrier that inhibits injection of charges from the charge storage portion to the potential well does not occur.

4: The ion sensor according to claim 1, wherein
the second electrode and the third electrode are spaced apart from each other, and
a second separation width between the second electrode and the third electrode is set in a range in which a potential barrier that inhibits transfer of charges from the potential well to the outside does not occur.

5: The ion sensor according to claim 1, wherein
a width of the third electrode in the facing direction is greater than or equal to 80% of the separation width between the first electrode and the second electrode.

6: The ion sensor according to claim 1, wherein
a portion of the first electrode overlaps with the third electrode when viewed in the thickness direction.

7: The ion sensor according to claim 6, wherein
the portion of the first electrode is disposed on an opposite side of the third electrode from the substrate.

8: The ion sensor according to claim 6, wherein
a width in the facing direction of a first portion of the first electrode that overlaps with the third electrode is smaller than a width in the facing direction of a second portion of the first electrode that does not overlap with the third electrode.

9: The ion sensor according to claim 8, wherein
the width of the first portion is smaller than or equal to 25% of the width of the second portion.

10: The ion sensor according to claim 1, wherein
a portion of the second electrode overlaps with the third electrode when viewed in the thickness direction.

11: The ion sensor according to claim 10, wherein
the portion of the second electrode is disposed on an opposite side of the third electrode from the substrate.

12: The ion sensor according to claim 10, wherein
a width in the facing direction of a third portion of the second electrode that overlaps with the third electrode is smaller than a width in the facing direction of a fourth portion of the second electrode that does not overlap with the third electrode.

13: The ion sensor according to claim 12, wherein
the width of the third portion is smaller than or equal to 25% of the width of the fourth portion.

14: The ion sensor according to claim 1, wherein
one pixel of the plurality of pixels includes a plurality of the ion sensitive films that react to ions different from each other,
a plurality of the fourth electrodes are provided corresponding to each of the plurality of the ion sensitive films, and
a plurality of the third electrodes are provided corresponding to each of the plurality of the fourth electrodes.

15: A method of manufacturing an ion sensor having: a substrate; and a first electrode, a second electrode, and a third electrode formed on the substrate, the method comprising:
forming a first insulating film on the substrate;
forming the first electrode, the second electrode spaced apart from the first electrode, and the third electrode spaced apart from both the first electrode and the second electrode between the first electrode and the second electrode on the first insulating film;
forming a second insulating film covering the first electrode, the second electrode, and the third electrode on the substrate;
forming an opening in the second insulating film such that a portion of the third electrode is exposed, and forming a metal wiring in the opening, the metal wiring being electrically connected to the third electrode;
forming a fourth electrode electrically connected to the metal wiring along a surface of the second insulating film opposite to the substrate side; and
forming an ion sensitive film on a surface of the fourth electrode opposite to the substrate side, the ion sensitive film changing a potential in accordance with a change in ion concentration of a medium in contact with the ion sensitive film,
wherein, in the forming the ion sensitive film, the ion sensitive film is formed such that a width of the ion sensitive film in a facing direction in which the first electrode and the second electrode face each other is greater than a separation width between the first electrode and the second electrode.

16: A method of manufacturing an ion sensor having: a substrate; and a first electrode, a second electrode, and a third electrode formed on the substrate, the method comprising:
forming a first insulating film on the substrate;
forming the third electrode on the first insulating film;
forming a second insulating film covering a surface of the third electrode;
forming the first electrode such that a portion of the first electrode overlaps with the third electrode via the second insulating film when viewed in a thickness direction of the substrate, and forming the second electrode such that a portion of the second electrode overlaps with the third electrode via the second insulating film when viewed in the thickness direction of the substrate;
forming a third insulating film covering the first electrode, the second electrode, and the third electrode on the substrate;
forming an opening in the third insulating film such that a portion of the third electrode is exposed, and forming a metal wiring in the opening, the metal wiring being electrically connected to the third electrode;
forming a fourth electrode electrically connected to the metal wiring along a surface of the third insulating film opposite to the substrate side; and
forming an ion sensitive film on a surface of the fourth electrode opposite to the substrate side, the ion sensitive film changing a potential in accordance with a change in ion concentration of a medium in contact with the ion sensitive film,
wherein, in the forming the ion sensitive film, the ion sensitive film is formed such that a width of the ion sensitive film in a facing direction in which the first electrode and the second electrode face each other is greater than a separation width between the first electrode and the second electrode.
